(19) United States
(12) Patent Application Publication
(10) Pub. No.: US 2026/0285124 A1
(43) Pub. Date: Sep. 24, 2026

(54) BATTERY AND AIR CONDITIONING CONTROL SYSTEM AND METHOD

(71) Applicants: HYUNDAI MOTOR COMPANY, Seoul (KR); KIA CORPORATION, Seoul (KR)

(72) Inventor: Ki Nam Jeon, Hwaseong-si (KR)

(73) Assignees: HYUNDAI MOTOR COMPANY, Seoul (KR); KIA CORPORATION, Seoul (KR)

(21) Appl. No.: 19/384,818

(22) Filed: Nov. 10, 2025

(30) Foreign Application Priority Data
Mar. 24, 2025 (KR) 10-2025-0036982

(51) Int. Cl. B60H 1/00; B60L 1/00; B60L 58/12; B60L 58/26; G05B 13/04; H01M 10/613; H01M 10/625; H01M 10/633

(52) U.S. Cl. CPC B60H 1/0073; B60H 1/00278; B60L 1/003; B60L 58/12; B60L 58/26; G05B 13/048; H01M 10/613; H01M 10/625; H01M 10/633; B60L 2240/525; B60L 2240/545; B60L 2240/547; B60L 2240/662; H01M 2220/20

(57) ABSTRACT

A battery and air conditioning control method includes receiving, by a prediction device, parameters of a plurality of first factors related to a battery thermal management system (BTMS) configured to manage a battery temperature of a vehicle and parameters of a plurality of second factors related to an air conditioning system configured to manage interior air conditioning of the vehicle. The battery and air conditioning control method also includes inputting, by the prediction device, the received parameters of the plurality of first and second factors to a temperature prediction model to predict an interior temperature of the vehicle. The method additionally includes controlling, by an integrated controller, the BTMS and the air conditioning system in an integrated manner based on the predicted interior temperature and one or more set target interior temperatures.

### CROSS-REFERENCE TO RELATED APPLICATION

This application claims the benefit of and priority to Korean Patent Application No. 10-2025-0036982, filed on Mar. 24, 2025, the entire contents of which are hereby incorporated herein by reference.

### TECHNICAL FIELD

The present disclosure relates to a battery and air conditioning control system and a method of controlling a battery and air conditioning system.

### BACKGROUND

The statements in this section merely provide background information related to the present disclosure and may not constitute prior art.

A loop-type air conditioning system included in a vehicle may be an air conditioning system designed to efficiently cool a large space, and may maintain a comfortable temperature inside the vehicle and provide a wider interior space.

Currently, an air conditioning system of a large vehicle such as a bus is controlled according to a uniform fixed value set in consideration of a worst operating environment (worst case) at the time of development. This does not reflect various variables of an actual operating environment, resulting in unnecessary energy consumption and system inefficiency. For example, energy is wasted due to the tendency to always maintain maximum cooling performance even when the actual operating conditions are not the worst, which also contributes to shortening battery life.

Further, in an air conditioning system to which a battery thermal management system (BTMS) is applied, air conditioning cooling and battery cooling are controlled only based on one representative temperature detecting value, which limits the ability to reflect a temperature deviation in multiple zones occurring in a wide interior space of the vehicle. In other words, optimal cooperative thermal management control for each zone in a large vehicle is not possible, which may lead to an imbalance in a perceived temperature and an increase in discomfort for passengers.

### SUMMARY

Various aspects of the present disclosure provide a battery and air conditioning control system and a method of controlling a battery and air conditioning system, that generate a temperature prediction model by using parameters for control factors of a battery thermal management system and an air conditioning system, predict in real time an interior temperature of a vehicle by using the temperature prediction model, and integrally control the battery thermal management system or the air conditioning system according to the predicted temperature so as to provide optimal air conditioning performance.

Technical aspects to be achieved by the present disclosure are not limited to the aspects described above. Other technical aspects that are not described herein should be more clearly understood by those having ordinary skill in the art to which the present disclosure pertains from the following description.

According to an embodiment of the present disclosure, a battery and air conditioning control system is provided. The battery and air conditioning control system includes a prediction device configured to receive parameters of a plurality of first factors related to a battery thermal management system (BTMS) configured to manage a battery temperature of a vehicle and parameters of a plurality of second factors related to an air conditioning system configured to manage interior air conditioning of the vehicle. The prediction device is also configured to input the received parameters of the plurality of first and second factors to a temperature prediction model to predict an interior temperature of the vehicle. The battery and air conditioning control system also includes an integrated controller configured to control the BTMS and the air conditioning system in an integrated manner based on the predicted interior temperature and one or more set target interior temperatures.

The plurality of first and second factors may include factors selected from among a plurality of candidate factors associated with a plurality of actuators included in the BTMS and the air conditioning system. The factors may be selected based on a predetermined condition of correlation with an average interior temperature of the vehicle.

The average interior temperature of the vehicle may be an average seat temperature of the vehicle.

The plurality of first and second factors may include two or more of a compressor temperature, an evaporator temperature, a battery cell temperature, a battery consumption voltage, a valve angle, an electric fan rotation speed, a refrigerant pressure, a warmer temperature, an inverter consumption current, an inverter temperature, a battery cooling sequence, an interior air temperature, an exterior air temperature, or a state of charge (SOC) change amount.

The prediction device may be further configured to receive parameters of third factors related to a driving state of the vehicle and input the parameters to the temperature prediction model.

The prediction device may be configured to predict the interior temperature of the vehicle for each of a plurality of zones from the parameters of the plurality of first and second factors.

The prediction device may further be configured to determine an average of the interior temperatures predicted for each of the plurality of zones.

The plurality of zones may include zones in which a driver seat, one or more passenger seats, and one or more vents of the vehicle are located.

The temperature prediction model may be trained based on the parameters of the plurality of first and second factors and an actual temperature detected for each of the plurality of zones of the vehicle.

The integrated controller may be configured to determine one or more target actuators to be controlled among a plurality of actuators included in the BTMS and the air conditioning system based on the predicted interior temperature and the one or more set target interior temperatures. The integrated controller may also be configured to generate, for each of the one or more target actuators, a control value for controlling the target actuators. The integrated controller may additionally be configured to output the generated control value to a system, among the BTMS and the air conditioning system, that includes the target actuator. The system that includes the target actuator may be configured to control operation of the target actuator based on the received control value.

According to another embodiment of the present disclosure, a battery and air conditioning control method is provided. The battery and air conditioning control method includes receiving, by a prediction device, parameters of a plurality of first factors related to a battery thermal management system (BTMS) configured to manage a battery temperature of a vehicle and parameters of a plurality of second factors related to an air conditioning system configured to manage interior air conditioning of the vehicle. The battery and air conditioning control method also includes inputting, by the prediction device, the received parameters of the plurality of first and second factors to a temperature prediction model. The battery and air conditioning control method additionally includes predicting, by the prediction device, using the temperature prediction model, an interior temperature of the vehicle based on the parameters of the plurality of first and second factors. The battery and air conditioning control method also includes controlling, by an integrated controller, the BTMS and the air conditioning system in an integrated manner based on the predicted interior temperature and one or more set target interior temperatures.

The plurality of first and second factors may include factors selected from among a plurality of candidate factors associated with a plurality of actuators constituting the BTMS and the air conditioning system. The factors may be selected based on a predetermined condition of correlation with an average interior temperature of the vehicle.

The average interior temperature of the vehicle may be an average seat temperature of the vehicle.

The plurality of first and second factors may include two or more of compressor temperature, evaporator temperature, exterior air temperature, battery cell temperature, battery consumption voltage, valve angle, electric fan rotation speed, refrigerant pressure, warmer temperature, inverter consumption current, inverter temperature, battery cooling sequence, interior air temperature, exterior air temperature, or state of charge (SOC) change amount.

The battery and air conditioning control method may further include receiving parameters of third factors related to a driving state of the vehicle and inputting the parameters of third factors to the temperature prediction model.

Predicting the interior temperature of the vehicle includes predicting the interior temperature of the vehicle for each of a plurality of zones, based on the parameters of the plurality of first and second factors.

The predicting the interior temperature of the vehicle may include determining an average of the interior temperatures predicted for each of the plurality of zones.

The plurality of zones may include zones in which a driver seat, one or more passenger seats, and one or more vents of the vehicle are located.

The temperature prediction model may be trained based on the parameters of the plurality of first and second factors and an actual temperature detected for each of the plurality of zones of the vehicle.

Controlling the BTMS and the air conditioning system in an integrated manner may include: determining, by the integrated controller, target actuators to be controlled among a plurality of actuators included in the BTMS and the air conditioning system based on the predicted interior temperature and the one or more set target interior temperatures; generating, by the integrated controller for each of the determined target actuators, a control value for controlling the determined target actuator; and outputting, by the integrated controller, the generated control value to a system, among the BTMS and the air conditioning system, that includes the target actuator. The BTMS and the air conditioning system may be configured to control operation of the target actuator based on the received control value.

According to embodiments of the present disclosure, it is possible to select a plurality of control factors for temperature control of a large vehicle having wider and more passenger seats than a general passenger car, and to improve passenger comfort by predicting and controlling temperatures of a plurality of zones in the large vehicle based on the selected plurality of control factors.

According to embodiments of the present disclosure, it is also possible to enhance temperature control performance for a plurality of zones by applying a temperature prediction model without additionally mounting components (for example, temperature sensors) to an existing BTMS (Battery Thermal Management System) air conditioning system or an existing air conditioner control system.

According to embodiments of the present disclosure, it is further possible to integrally control the BTMS and the air conditioning system applied to an eco-friendly commercial vehicle, thereby optimizing performance of the BTMS and the air conditioning system and improving stability.

According to embodiments of the present disclosure, it is also possible to reduce power consumption through efficient thermal energy management, improve energy efficiency, and enhance durability of auxiliary loads by predicting temperatures of a plurality of zones inside a vehicle and adaptively controlling the BTMS and the air conditioning system.

Effects that can be obtained from the present disclosure are not limited to the effect described above. Other effects that are not described herein should be more clearly understood by those having ordinary skill in the art to which the present disclosure pertains from the following description.

### BRIEF DESCRIPTION OF THE DRAWINGS

The above and other objects, features, and advantages of the present disclosure should become more apparent to those of ordinary skill in the art from the following detailed description taken in conjunction with the accompanying drawings, in which:

FIG. 1 is a diagram illustrating a vehicle, according to an embodiment of the present disclosure;

FIG. 2 is a block diagram schematically illustrating a battery and air conditioning control system, according to an embodiment of the present disclosure;

FIG. 3 is a diagram illustrating a part of a cooling processing unit, according to an embodiment of the present disclosure;

FIG. 4 is a diagram illustrating a part of an air conditioning processing unit, according to an embodiment of the present disclosure;

FIG. 5 is a block diagram illustrating an integrated controller, according to an embodiment of the present disclosure;

FIG. 6A is a diagram illustrating an operation of selecting first to third factors from first to third candidate factors, according to an embodiment of the present disclosure;

FIG. 6B is a diagram illustrating a correlation coefficient, according to an embodiment of the present disclosure;

FIG. 7 is a block diagram illustrating a prediction device, according to an embodiment of the present disclosure;

FIG. 8A is a diagram illustrating the plurality of zones of a vehicle, according to an embodiment of the present disclosure;

FIG. 8B is a diagram illustrating identification information of the plurality of zones illustrated in FIG. 8A, according to an embodiment of the present disclosure;

FIG. 9 is a diagram illustrating a series of processes of predicting temperatures of the plurality of zones using a temperature prediction model, according to an embodiment of the present disclosure;

FIG. 10 is a diagram illustrating time-series temperatures predicted in H1L among the plurality of zones, according to an embodiment of the present disclosure; and

FIG. 11 is a flowchart illustrating a battery and air conditioning control method, according to an embodiment of the present disclosure.

### DETAILED DESCRIPTION

Hereinafter, embodiments of the present disclosure are described in detail with reference to the accompanying drawings to enable those having ordinary skill in the art to implement and practice the present disclosure. However, the present disclosure may be implemented in various different ways, and is not limited to the embodiments described therein.

In the following description, where it was determined that a detailed description of well-known functions or constructions would obscure the gist the present disclosure, the detailed description thereof has been omitted. The same constituent elements in the drawings are denoted by the same reference numerals, and a repeated description of the same elements has been omitted.

In the present disclosure, when an element is simply referred to as being “connected to”, “coupled to” or “linked to” another element, this may mean that the element is “directly connected to”, “directly coupled to” or “directly linked to” the other element, or is connected to, coupled to or linked to the other element with one or more further elements intervening therebetween. In addition, when an element “includes” or “has” another element, this means that the element may further include another element without excluding another element, unless specifically stated otherwise herein.

In the present disclosure, the terms first, second, etc. may be used. Such terms are merely used to distinguish one element from another and do not limit the order or the degree of importance between the elements unless specifically mentioned herein. Accordingly, a first element in an embodiment could be termed a second element in another embodiment, and, similarly, a second element in an embodiment could be termed a first element in another embodiment, without departing from the scope of the present disclosure.

In the present disclosure, elements that are distinguished from each other are for clearly describing each feature, and do not necessarily mean that the elements are separated. For example, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In the present disclosure, elements described in various embodiments do not necessarily mean essential elements, and some of the elements may be optional elements. Therefore, an embodiment composed of a subset of elements described in an embodiment is also included in the scope of the present disclosure. In addition, embodiments including other elements in addition to the elements described in the various embodiments are also included in the scope of the present disclosure.

The advantages and features of the present disclosure and the way of attaining them should become more apparent with reference to embodiments described below in detail taken in conjunction with the accompanying drawings. The present disclosure, however, may be embodied in many different forms and should not be constructed as being limited to example embodiments set forth herein. Rather, these described embodiments are provided to make this disclosure complete and to fully convey the scope of the present disclosure to those having ordinary skill in the art.

In the present disclosure, each of phrases such as “A or B”, “at least one of A and B”, “at least one of A or B”, “A, B or C”, “at least one of A, B and C”, “at least one of A, B or C” and “at least one of A, B, C, or combination thereof” may include any one or all possible combinations of the items listed together in the corresponding one of the phrases.

When a component, controller, device, element, apparatus, unit, or the like of the present disclosure is described as having a purpose or performing an operation, function, or the like, the component, controller, device, element, apparatus, unit or the like should be considered herein as being “configured to” meet that purpose or to perform that operation or function. Each component, controller, device, element, apparatus, unit, and the like may separately embody or be included with a processor and a memory, such as a non-transitory computer readable media, as part of the apparatus.

Hereinafter, embodiments of the present disclosure are described in detail with reference to the accompanying drawings.

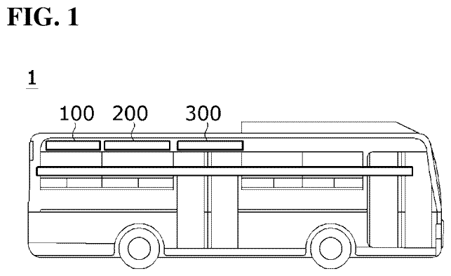

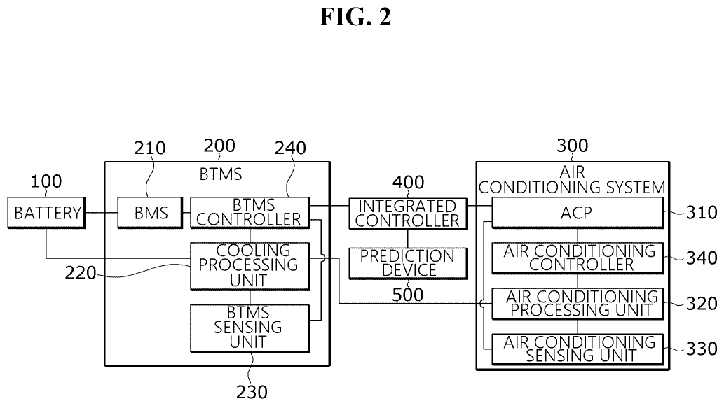

FIG. 1 is a diagram illustrating a vehicle 1 according to an embodiment of the present disclosure. FIG. 2 is a block diagram illustrating a battery and air conditioning control system according to an embodiment of the present disclosure.

Referring to FIGS. 1 and 2, a vehicle 1 according to an embodiment of the present disclosure may include a battery 100, a battery thermal management system (BTMS) 200, an air conditioning system 300, an integrated controller 400, and a prediction device 500.

The vehicle 1 may be a hybrid type vehicle that is driven based on electric energy using the battery 100, or is driven by selectively using a fossil fuel-based internal combustion engine and the battery 100.

The vehicle 1 may be a typical passenger vehicle, commercial vehicle, or purpose built vehicle (PBV) as well as the illustrated bus. The vehicle 1 may be a four-wheel vehicle (for example, a passenger car, an SUV, or a small truck), or a vehicle with more than four wheels (for example, a bus, a large truck, a container transport vehicle, or a heavy equipment vehicle).

The vehicle 1 may be controlled and driven autonomously, and autonomous driving may be implemented as semi-autonomous driving or fully autonomous driving. Fully autonomous driving may be provided as autonomous movement in which a processor of the vehicle 1 maintains complete control without user intervention even when a driving situation is uncertain. Semi-autonomous driving may be provided as autonomous movement that requires driver intervention in some specific driving situations.

The battery 100 may include a plurality of battery cells or a plurality of battery modules. The battery 100 may be a high-voltage battery that stores energy for driving the electric vehicle 1. One battery module may include a plurality of battery cells.

The battery 100 and the BTMS 200 may be integrated as a single battery pack. The BTMS 200 and the air conditioning system 300 may be provided in a roof of the vehicle 1, for example. However, locations at which the BTMS 200 and the air conditioning system 300 are provided may be changed without departing from the spirit and scope of the present disclosure.

The BTMS 200 may be responsible for cooling and heating the battery 100 to ensure that an internal or external temperature of the battery 100 is within an optimal operating temperature range. This is because, when a temperature of a battery used in an electric vehicle or hybrid vehicle exceeds an optimal operating temperature range, battery performance and battery life are rapidly reduced and nearby components are affected.

Further, the BTMS 200 may manage heat of the battery 100 in conjunction with a battery management system (BMS) 210. The BTMS 200 may include the BMS 210 or may be provided independently of the BMS 210. In the present disclosure, a configuration in which the BTMS 200 includes the BMS 210 is described as an example, but it should be apparent to those having ordinary skill in the art that the present disclosure is not limited thereto.

As illustrated in FIG. 2, the BTMS 200 may include the BMS 210, a cooling processing unit 220, a BTMS sensing unit 230, and a BTMS controller 240.

The BMS 210 may collect battery data such as voltage, current, temperature, and state of charge (SOC) of the battery 100 in real time, may analyze the collected battery data to monitor and determine a state of the battery 100, and may control charging and/or discharging.

Further, the BMS 210 may transmit the battery data to the BTMS controller 240 or the integrated controller 400 through a CAN communication cable, and may receive response data corresponding to the battery data from the BTMS controller 240 or the integrated controller 400.

For example, when the battery 100 is determined to be overheated based on detected battery temperature, the BMS 210 may transmit the detected battery temperature and a signal for requesting battery cooling activation to the BTMS controller 240, and the BTMS controller 240 may circulate coolant, operate a cooling fan, and feed a coolant temperature back to the BMS 210. When the detected battery temperature reaches a reference temperature again, the BMS 210 may transmit a signal for requesting cooling stop to the BTMS controller 240.

The cooling processing unit 220 may manage the battery 100 to ensure that the temperature of the battery 100 is maintained within an appropriate range.

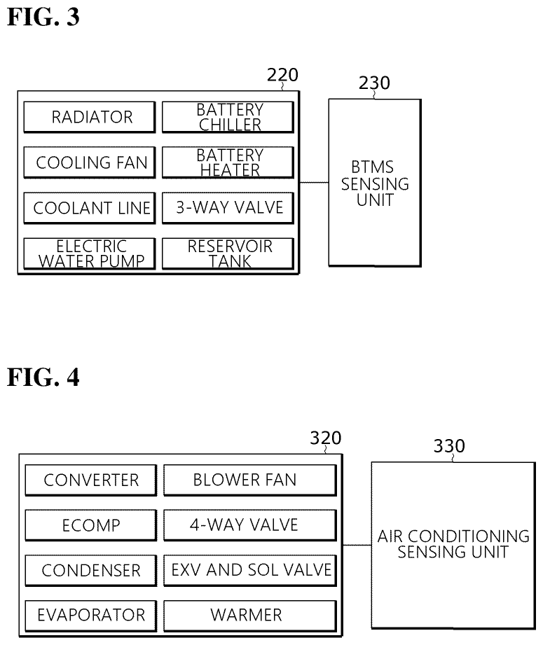

FIG. 3 is a diagram illustrating a part of the cooling processing unit 220, according to an embodiment of the present disclosure.

Referring to FIG. 3, the cooling processing unit 220 may include a number of components, such as a radiator, a cooling fan, a coolant line, an electric water pump, a battery chiller, a battery heater, a 3-way valve, a reservoir tank, and an inverter (not shown). Hereinafter, the components of the cooling processing unit 220 are referred to as actuators of the cooling processing unit 220.

For example, the radiator and the cooling fan dissipate or cool the coolant, the coolant line circulates the coolant between the battery 100 and the cooling processing unit 220, and the electric water pump pumps the coolant so that the coolant circulates in the coolant line. The battery chiller cools the coolant using the refrigerant of the air conditioning system 300, and the battery heater generates heat to heat the coolant. The 3-way valve provides a route for sending the coolant to the battery 100 or bypassing the coolant, and the reservoir tank stores the coolant.

The BTMS sensing unit 230 may be included in the actuators of the cooling processing unit 220 and the reservoir tank to detect cooling data related to the cooling processing unit 220. The BTMS sensing unit 230 includes, for example, a battery temperature sensor included in the battery 100, a coolant temperature sensor included in the coolant line or the reservoir tank, and a coolant level sensor included in the reservoir tank, and further includes sensors necessary for detecting the cooling data.

Examples of the cooling data may include all values that can be detected from the cooling processing unit 220, including inlet and outlet temperatures of each actuator, inlet and outlet voltages of each actuator, coolant temperature, coolant water level, refrigerant pressure, and valve angle.

Referring back to FIG. 2, the BTMS controller 240 may manage or control an operation of the BTMS 200 based on the battery data received from the BMS 210 and the cooling data received from the BTMS sensing unit 230. Further, the BTMS controller 240 may also be responsible for communication between the BMS 210 and the integrated controller 400. The BTMS controller 240 may be an electronic control unit (ECU) including at least one memory and at least one processor and may communicate with the BMS 210 and the integrated controller 400 using CAN communication or LIN communication.

Hereinafter, the received battery data and cooling data are referred to as “parameters of first candidate factors related to the BTMS 200.” Therefore, the BTMS controller 240 may set the received battery data and cooling data as the parameters of the first candidate factors and then transmit the data to the integrated controller 400.

The first candidate factor may be an item indicating a state of the BTMS 200 or the battery 100, and includes items that may be detected by the battery 100 and the BTMS sensing unit 230 or calculated (or otherwise determined) by the BMS 210 or the BTMS controller 240. For example, the first candidate factor includes not only an inlet temperature and outlet temperature, inlet voltage and outlet voltage, coolant temperature, coolant water level, refrigerant pressure, and valve angle of each actuator included in the cooling processing unit 220, but also all items that can be detected by the BTMS sensing unit 230.

Further, the BTMS controller 240 may receive a control value for controlling the cooling processing unit 220 of the BTMS 200 from the integrated controller 400, and may generate a control signal for driving the actuator of the cooling processing unit 220 based on the received control value. For example, when the received control value is related to a cooling fan, the BTMS controller 240 may generate a control signal for driving the cooling fan, and control the cooling fan so that the cooling fan operates according to the generated control signal.

The BTMS controller 240 may be an ECU, and may include a first interface module, a first memory, and a first processor.

The first interface module may include a communication interface for communicating with the BMS 210, the integrated controller 400, and the air conditioning system 300, and a sensor interface that receives the battery data from the BMS 210, receives the cooling data from the sensing unit, and converts the received data into a signal using an AD converter when necessary.

The first memory may store program codes (e.g., in the form of computer-readable instructions), various types of data, and setting values necessary for control of the BTMS 200, the battery data received from the BMS 210, and the cooling data received from the cooling processing unit 220. The first memory may include a volatile memory and/or a nonvolatile memory.

The first processor may control the BTMS 200 based on the received battery data or cooling data. Further, the first processor may transmit the received battery data or cooling data, i.e., parameters of a plurality of first candidate factors, to the integrated controller 400. Further, the first processor may generate a control signal for driving each actuator of the cooling processing unit 220 based on the control value received from the integrated controller 400, and may control the driving of the cooling processing unit 220 based on the generated control signal.

The air conditioning system 300 may be a system that manages the interior air conditioning (heating, cooling, ventilation) of the vehicle 1. The air conditioning system 300 may include an air control panel (ACP) 310, an air conditioning processing unit 320, an air conditioning sensing unit 330, and an air conditioning controller 340.

The ACP 310 may receive a desired driving mode or target interior temperature from a user, and transmit a signal corresponding to the input driving mode or target interior temperature to the air conditioning controller 340. Examples of the driving mode include various modes such as a cooling mode, a heating mode, a ventilation mode, and a cleaning mode. Further, the ACP 310 may display temperatures inside and outside the vehicle 1.

The air conditioning processing unit 320 may maintain an interior temperature of the vehicle 1 at the target interior temperature.

FIG. 4 is a diagram illustrating a part of the air conditioning processing unit 320, according to an embodiment.

Referring to FIG. 4, the air conditioning processing unit 320 includes a converter, an electric compressor (ECOMP), a condenser, an evaporator, a blower fan, a 4-way valve, EXV and SOL valves, a warmer, and an inverter (not shown), and separate components may be added or removed. Hereinafter, the converter, the electric compressor (ECOMP), the condenser, the evaporator, the blower fan, the 4-way valve, the EXV and SOL valves, the warmer, and the inverter are referred to as components or actuators of the air conditioning processing unit 320.

For example, in the cooling mode, the converter may convert power from a high-voltage battery (for example, with DC 600 V to 800 V) into a low voltage (for example, DC 24 V) and supply the voltage to the air conditioning system 300 and electrical components. The electric compressor compresses the refrigerant to convert the refrigerant into the refrigerant in a high-temperature and high-pressure state, and then transfers the converted refrigerant to the condenser. The condenser condenses the compressed refrigerant to convert the refrigerant into the refrigerant in a liquid state, and the condensed refrigerant expands to reach a low-temperature and low-pressure state through the EXV and SOL valves. The 4-way valve provides a flow path for movement of the cooled refrigerant to at least one of the evaporator and the BTMS 200, the evaporator vaporizes the cooled refrigerant, and the vaporized refrigerant is supplied to the interior through the blower fan to cool the room air. When the interior temperature reaches the target temperature, the electric compressor adjusts an output to adjust a cooling capacity. The EXV and SOL valves switch a flow of refrigerant or cooling water to switch between the heating mode and the cooling mode. For example, in the cooling mode, the refrigerant is sent to the evaporator, and in the heating mode, the refrigerant is sent to the warmer.

In the heating mode, the EXV and SOL valves provide a flow path for movement of the refrigerant to the warmer, and the warmer heats the refrigerant. A heater core warms the air using the coolant or refrigerant heated by the engine, and the warmed air is supplied to the vehicle interior through the blower fan.

The air conditioning sensing unit 330 may be included in the actuators of the air conditioning processing unit 320 and may detect air conditioning data related to the air conditioning processing unit 320. The air conditioning sensing unit 330 may include, for example, sensors necessary for detecting the air conditioning data, such as an exterior air temperature sensor that detects an exterior air temperature of the vehicle 1, a refrigerant temperature sensor, a refrigerant pressure sensor, a temperature sensor provided in an inlet and outlet of the electric compressor, an angle sensor provided in the valve, and an electric fan rotation speed sensor.

Examples of the air conditioning data may include all values that can be detected from the air conditioning processing unit 320, including inlet and outlet temperatures of each actuator, inlet and outlet voltages of each actuator, a refrigerant temperature, a refrigerant pressure, and a valve angle.

Referring back to FIG. 2, the air conditioning controller 340 may be an HVAC control unit (HCU) that controls the air conditioning system 300, and may manage or control the operation of the air conditioning system 300 based on the air conditioning data received from the air conditioning sensing unit 330. Further, the air conditioning controller 340 may communicate with the integrated controller 400 using CAN communication, LIN communication, or the like. For example, the air conditioning controller 340 may transmit the air conditioning data to the integrated controller 400 and receive the control value from the integrated controller 400.

Hereinafter, the detected air conditioning data is referred to as “parameters of second candidate factors related to the air conditioning system 300.” Therefore, the air conditioning controller 340 may determine the air conditioning data as parameters of the second candidate factors and then transmit the air conditioning data to the integrated controller 400.

The second candidate factor is an item indicating a state of the air conditioning system 300, and further includes, for example, an item that can be detected by the air conditioning sensing unit 330 or calculated (or otherwise determined) by the air conditioning controller 340 for control of the air conditioning system 300. For example, the second candidate factor may further include all items that can be detected by the air conditioning sensing unit 330, such as an inlet temperature and an outlet temperature of each actuator included in the air conditioning processing unit 320, an inlet voltage and outlet voltage, an electric fan rotation speed, a warmer temperature, inverter current consumption, an inverter temperature, an exterior air temperature, a refrigerant temperature, and a refrigerant pressure.

Further, the air conditioning controller 340 may receive a control value for controlling the air conditioning processing unit 320 from the integrated controller 400 and generate a control signal for driving the actuator of the air conditioning processing unit 320 based on the received control value. For example, when the received control value is related to the converter, the air conditioning controller 340 may generate a control signal for driving the converter and control the converter so that the converter operates according to the generated control signal.

The air conditioning controller 340 may include a second interface module, a second memory, and a second processor.

The second interface module may include a communication interface for communicating with the integrated controller 400 or the BTMS 200, and a sensor interface that receives the air conditioning data from the air conditioning sensing unit 330 and converts the received data into a signal using an AD converter when necessary.

The second memory may store program codes (e.g., in the form of computer-readable instructions), various types of data, setting values, and the air conditioning data required for control of the air conditioning system 300, and may include a volatile memory and a nonvolatile memory.

The second processor may control the air conditioning processing unit 320 so that the air conditioning system 300 maintains the target temperature based on the detected air conditioning data. Further, the second processor may transmit the received air conditioning data, that is, the parameters of the plurality of received second candidate factors, to the integrated controller 400. Further, the second processor may generate a control signal for driving each actuator of the air conditioning processing unit 320 based on the control value received from the integrated controller 400.

The integrated controller 400 may control the BTMS 200 and the air conditioning system 300 in an integrated manner or in a coordinated control manner so that both the battery 100 and the interior of the vehicle 1 simultaneously or concurrently maintain an optimal temperature. The integrated controller 400 may be, for example, a vehicle control unit (VCU).

For example, when the battery 100 is determined to be overheated based on the temperature of the battery 100 among the parameters of the first candidate factors received from the BTMS 200, the integrated controller 400 may generate a control value so that the temperature of the battery 100 is maintained at an appropriate temperature through cooperation between the cooling processing unit 220 and the air conditioning processing unit 320, and transmit the generated control value to the cooling processing unit 220 and the air conditioning processing unit 320. Accordingly, the water pump of the cooling processing unit 220 may circulate the coolant, the 3-way valve may provide a flow path for sending the coolant to the battery, and the cooling fan may cool the coolant so that the battery 100 is cooled. Further, when cooperative control is required, the air conditioning system 300 may use the refrigerant to cool the battery 100 more rapidly. On the other hand, the air conditioning system 300 may also use the heat of the battery 100 to heat the interior.

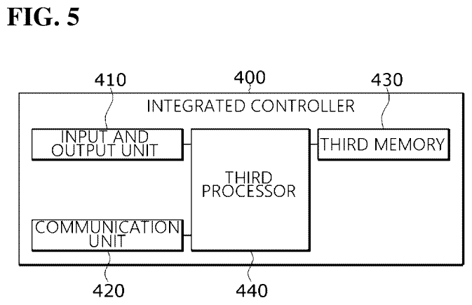

FIG. 5 is a block diagram illustrating the integrated controller 400 according to an embodiment of the present disclosure.

Referring to FIG. 5, the integrated controller 400 according to an embodiment of the present disclosure may include an input and output unit 410, a communication unit 420, a third memory 430, and a third processor 440.

The input and output unit 410 may receive driving state data from driving sensors (not shown) related to the driving state of the vehicle 1 and convert the received driving state data into a form that can be processed by the third processor 440. The data related to the driving state is parameters of third candidate factors related to the driving state of the vehicle 1.

The third candidate factor is an item related to a driving state of the driving vehicle 1 and includes wheel speed, inclination, driving direction, vehicle wheel speed, driving direction, vehicle attitude, vehicle inclination, vehicle weight, vehicle fuel amount, tire pressure, steering angle, vehicle interior temperature and humidity, pedal position, engine temperature, and route information.

The communication unit 420 may transmit and receive data with the battery 100, the BTMS 200, the air conditioning system 300, or the prediction device 500 through a CAN or LIN communication protocol. For example, the communication unit 420 may receive the parameters of the first candidate factors from the BTMS 200 and the parameters of the second candidate factors from the air conditioning system 300.

Further, the communication unit 420 may transmit parameters of first factors, parameters of second factors, or parameters of third factors to the prediction device 500 and may receive the predicted interior temperature of the vehicle 1 from the prediction device 500.

The third memory 430 may store program codes (e.g., in the form of computer-readable instructions), various types of data, setting values, parameters of the first to third candidate factors, the first to third factors, parameters of the first to third factors, and one or more target interior temperatures required for control of the integrated controller 400. The third memory 430 may include a volatile memory and/or a nonvolatile memory.

The third processor 440 may collect and analyze the parameters (e.g., the battery data, the cooling data, the air conditioning data, vehicle driving state data, and the like) of the first to third candidate factors received from the BTMS 200, the air conditioning system 300, and driving sensors (not shown) to determine the state of the battery 100, the state of the BTMS 200, and the state of the air conditioning system 300. The third processor 440 may generate a control value for controlling the battery 100, the BTMS 200, or the air conditioning system 300 based on a determination result, and may then perform processing so that the control value is transmitted to the battery 100, the BTMS 200, or the air conditioning system 300. For example, the third processor 440 may coordinate the operations of the BTMS 200 and the air conditioning system 300 (for example, RPM distribution) to maximize energy efficiency and maintain interior comfort.

Further, the third processor 440 may select the parameters of the first to third factors from the received parameters of the first to third candidate factors, and perform processing so that the selected parameters of the first to third factors are transmitted to the prediction device 500. The parameters are actual detecting values or actual measured values of all the factors.

The first factor is a factor selected from among all first candidate factors indicating the state of the BTMS 200 or the battery 100. The first factor may be determined in advance. For example, the BTMS controller 240 may receive the parameters of the plurality of first candidate factors related to the BTMS 200 from the BMS 210, the cooling processing unit 220, and the BTMS sensing unit 230, and may transmit the received parameters of the plurality of first candidate factors to the integrated controller 400. The parameters of the plurality of first candidate factors related to the BTMS 200 may include the battery data received from the BMS 210 and the cooling data that may be acquired from the actuators of the cooling processing unit 220 and the reservoir tank.

The second factor is a factor selected from among all the second candidate factors indicating the state of the air conditioning system 300. The second factor may be determined in advance. For example, the air conditioning controller 340 may receive the parameters of the plurality of second candidate factors related to the air conditioning system 300 from the BMS 210, the cooling processing unit 220, and the BTMS sensing unit 230, and may transmit the received parameters of the plurality of second candidate factors to the integrated controller 400. The parameters of the plurality of second candidate factors related to the air conditioning system 300 may include the air conditioning data received from the air conditioning sensing unit 330.

The third factor is a factor selected from among all third candidate factors related to the driving state. The third factor may be determined in advance.

The first factor, the second factor, and the third factor may be selected based on the correlation with an average interior temperature of the vehicle 1 satisfying predetermined conditions from among the first to third candidate factors that may be acquired from the plurality of actuators 220 and 320 and driving sensors (not shown) constituting the BTMS 200 and the air conditioning system 300, and may be factors having a high influence on the average interior temperature of the vehicle. The average interior temperature of the vehicle 1 may be an average temperature of the seats of the vehicle 1 or the plurality of zones described in more detail below.

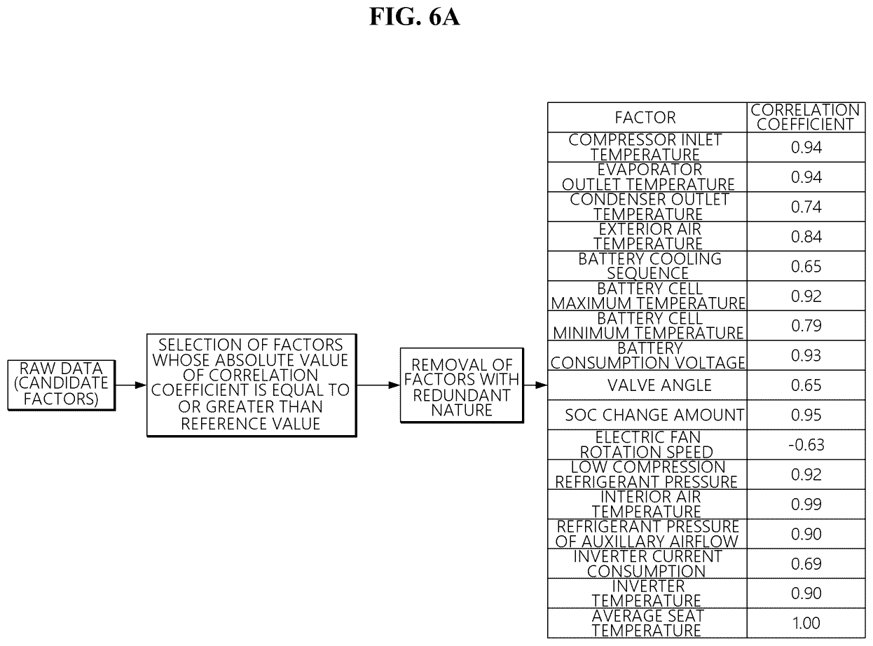

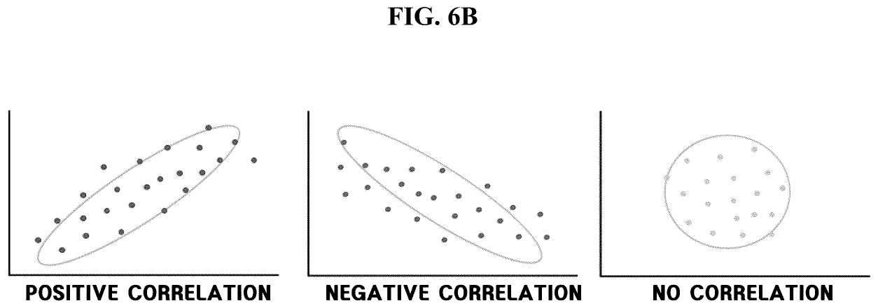

FIG. 6A is a diagram illustrating an operation of selecting the first factor, the second factor, and the third factors from the first candidate factors, the second candidate factors, and the third candidate factors, respectively, according to an embodiment. FIG. 6B is a diagram illustrating a correlation coefficient, according to an embodiment.

Referring to FIG. 6A, a selection module (not shown) nay receive, for example, 67 first to third candidate factors as raw data. The selection module (not shown) may calculate or otherwise determine a correlation coefficient between the raw data, i.e., each of the first candidate factors, the second candidate factors, and the third candidate factors, and the average interior temperature. The correlation coefficient indicates an influence of each candidate factor on an increase or decrease of the average interior temperature.

Referring to FIG. 6B, the selection module (not shown) may utilize a Python heat map library to confirm a Pearson correlation coefficient. The selection module (not shown) may determine that the correlation is very high when the influence of each candidate factor on the average interior temperature is close to ±1, and the correlation is very low or zero when the influence is close to 0.

The selection module (not shown) may first select the first factors, the second factors, and the third factors whose absolute values of the 67 calculated or otherwise determined correlation coefficients are equal to or greater than a reference value (for example, 0.6, which may be changed). The number of the first to third factors that are first selected may be, for example, 24. The selection module (not shown) may further remove one factor with a redundant nature from each of the first to third factors that have been first selected, to finally select the first to third factors. The factors with a redundant nature include, for example, the inlet temperature and outlet temperature of the compressor, and in the case of FIG. 6, the outlet temperature of the compressor is removed. The selection module (not shown) may finally select 16 factors by removing the factors with a redundant nature, and in the case of FIG. 6A, the third factors are not included and the average interior temperature is further included.

The selection module (not shown) may be included in the integrated controller 400 or may be implemented as a separate computing device. When the selection module is implemented as a separate device, identification information for the first to third factors that are finally selected may be provided to the integrated controller 400. As a result, the integrated controller 400 may transmit the parameters of the first to third factors having the received identification information to the prediction device 500.

The third processor 440 may generate a control value for controlling the BTMS 200 or the air conditioning system 300 in an integrated manner based on the predicted interior temperature of the vehicle 1 received from the prediction device 500 and one or more target interior temperatures, and may perform processing so that the generated control value is transmitted to the BTMS 200 or the air conditioning system 300. The one or more target interior temperatures may be a target temperature set for each zone when the interior of the vehicle 1 is divided into a plurality of zones.

In an embodiment, the third processor 440 may determine one or more target actuators to be controlled among a plurality of actuators constituting the BTMS 200 and the air conditioning system 300 based on the predicted interior temperature and one or more target interior temperatures, and may generate a control value for controlling the one or more determined target actuators. The third processor 440 may output the generated control value to a system including at least one target actuator in the BTMS 200 and the air conditioning system 300. Therefore, the system that has received the control value among the BTMS 200 and the air conditioning system 300 may control the operation of the target actuator based on the received control value.

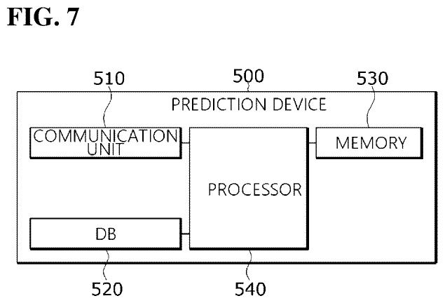

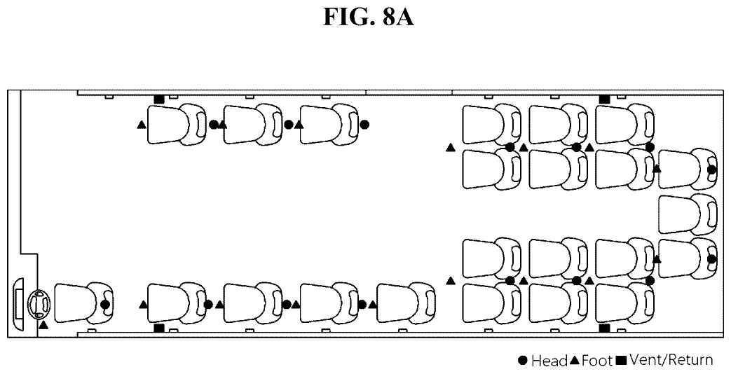

FIG. 7 is a block diagram illustrating the prediction device 500 according to an embodiment of the present disclosure.

The prediction device 500 may be an on-device installed in the vehicle 1 to collect and process data. The prediction device 500 may predict the interior temperature of the driving vehicle 1 based on a temperature prediction model and transmit the predicted interior temperature to the integrated controller 400. For example, the prediction device 500 may learn the model using a feature importance scheme. The feature importance scheme is an algorithm that selects factors highly related to the output as inputs and learns in order to improve the generalization performance and complexity of the prediction model.

Referring to FIG. 7, the prediction device 500 may include a communication unit 510, a database (DB) 520, a memory 530, and a processor 540.

The communication unit 510 may communicate with the integrated controller 400 through wired or wireless communication. The communication unit 510 may include at least one of various modules, such as a cellular communication module, a Wi-Fi module, a Bluetooth module, a vehicle-to-everything (V2X) communication module, a CAN gateway, and an Ethernet communication module.

The DB 520 may store the parameters of the first to third factors received from the integrated controller 400 and the interior temperature data of the vehicle 1. The interior temperature of the vehicle may be included in the first to third factors or may be received separately from a temperature sensor in the vehicle 1.

The memory 530 may store at least one program (for example, an operating system, software, firmware, middleware, or an application), various types of data, and at least one command or computer-readable instruction for control of the prediction device 500, and may load the program, read or write the data, or perform an operation corresponding to the command in response to a request from the processor 540. The memory 530 may include a volatile memory and/or a nonvolatile memory. The memory 530 may store a program (e.g., in the form of computer-readable instructions) for generating the temperature prediction model and the generated temperature prediction model.

The processor 540 may perform overall control of the prediction device 500 according to an input command. The command may be input to the processor 540 by the memory 530 or the communication unit 510. For example, the processor 540 may execute the program or command stored in the memory 530 to perform data processing and computation.

Further, the processor 540 may load commands or data received from other components into a volatile memory, process the commands or data stored in the volatile memory, and store processing results in a nonvolatile memory.

In an embodiment of the present disclosure, the processor 540 may learn the parameters of the first to third factors collected while the vehicle 1 is driving for a certain period of time, and temperature data of the plurality of zones of the vehicle 1 detected at the same time points as the parameters of the first to third factors or time points within an error range to generate the temperature prediction model that predicts a time-series temperature. Further, the processor 540 may predict a near future temperature in a time series format using the generated temperature prediction model.

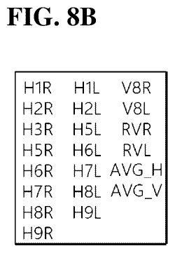

FIG. 8A is a diagram illustrating the plurality of zones of the vehicle 1, according to an embodiment.

Referring to FIG. 8A, the plurality of zones distinguished for real-time temperature measurement in the interior of the vehicle 1 may include a head, a foot, a vent, and a return vent. The head is an upper part of a seat, the foot is a bottom part of the seat where measurement is taking place, the vent is a vent provided at a rear part of the vehicle 1 to discharge air, and the return is a return vent provided in a front part of the vehicle 1 to draw air.

FIG. 8B shows identification information of the plurality of zones illustrated in FIG. 8A, according to an embodiment.

Referring to FIG. 8B, H1R is a head part of a right seat in a first row, and H1L is a head part of a left seat in the first row. V8R is a right vent in an eighth row, and RVR is a return vent on the right. AVG_H is an average temperature of seats (head), and AVG_V is an average temperature of the vents and the return vents.

Hereinafter, an operation of generating the temperature prediction model, according to an embodiment, is described in more detail.

The processor 540 may map the parameters of the first to third factors collected while the vehicle 1 is actually driving and temperature data of the plurality of zones in the same time period and store the parameters and the temperature data in the DB 520. When big data is secured by collecting data for a certain period of time, the processor 540 may input the parameters of the (for example, 16) first to third factors that have been collected, the parameter of the average seat temperature AVG_H, and the actually detected temperature data of the plurality of zones to an artificial intelligence model to perform machine learning, and as a result, may generate a temperature prediction model that can predict a near future temperature while the vehicle 1 is actually driving.

Further, the processor 540 may determine the accuracy of the temperature prediction model using test data, and may store the temperature prediction model in the memory 530 when the accuracy is higher than a reference value. Thereafter, while the vehicle 1 is driving, the processor 540 may input the parameters of the first to third factors received in real time to the temperature prediction model to predict the near future interior temperature of the vehicle 1 in a time-series form.

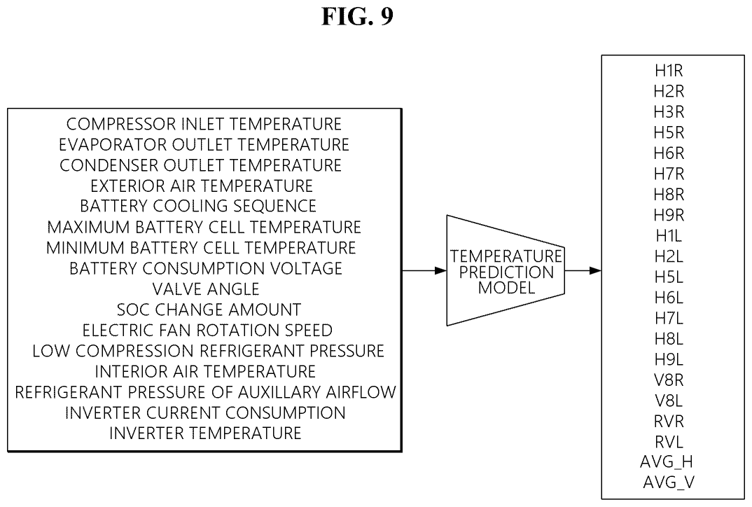

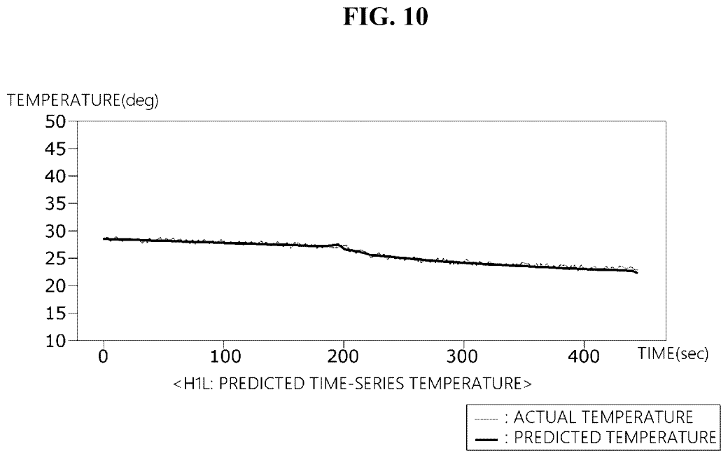

FIG. 9 is a diagram illustrating a series of processes of predicting the temperature of the plurality of zones using the temperature prediction model, according to an embodiment. FIG. 10 is a diagram illustrating a time-series temperature predicted in H1L among the plurality of zones, according to an embodiment.

Referring to FIG. 9, the processor 540 may input parameters of 16 first to third factors to the temperature prediction model to predict time-series temperatures of 19 zones and two average temperatures. These numbers are an example and are not limiting. Referring to FIG. 10, it can be seen that the predicted temperature and the actual temperature are substantially the same for the H1L of the seat.

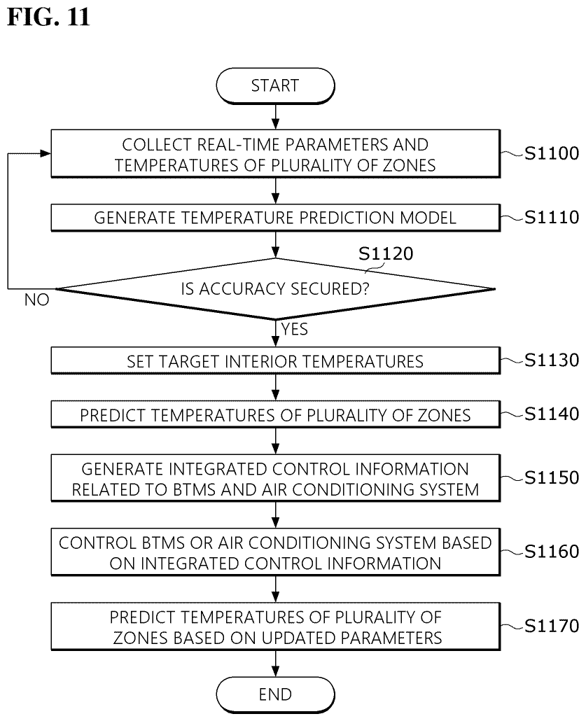

FIG. 11 is a flowchart illustrating a battery and air conditioning control method, according to an embodiment of the present disclosure.

Referring to FIG. 11, in an operation S1110, the prediction device 500 may collect parameters of a plurality of first factors related to the BTMS 200 that manages the battery temperature of the vehicle 1, a plurality of second factors related to the air conditioning system 300 that manages the interior air conditioning of the vehicle 1, and the interior temperature measured for each of the plurality of zones.

In an operation S1110, e.g., when big data is collected, the prediction device 500 may learn the collected parameters of the first and second factors and the interior temperature of the plurality of zones to generate the temperature prediction model.

The prediction device 500 may input test data to the generated temperature prediction model to calculate (or otherwise determine) accuracy, and may activate the temperature prediction model when the accuracy is secured (Yes in an operation S1120).

In an operation S1130, the prediction device 500 may receive one or more target interior temperatures of the vehicle 1 that may be set by a user. In an operation S1140, the prediction device 500 may input parameters of the first to third factors to the temperature prediction model to predict the temperatures of the plurality of zones and the average interior temperature. In operation the operation S1140, the parameters of the first to third factors selected from among the first to third candidate factors may be received from the integrated controller 400, and for example, the parameters of the candidate factor whose correlation coefficient is equal to or smaller than the reference value among the first to third candidate factors may not be received.

The prediction device 500 may transmit the predicted interior temperature to the integrated controller 400. In an operation S1150, the integrated controller 400 may generate a control value (that is, integrated control information) for integrated control of the BTMS 200 and the air conditioning system 300.

In an operation S1160, the integrated controller 400 may control the BTMS 200 or the air conditioning system 300 so that the BTMS 200 or the air conditioning system 300 operates based on the generated integrated control information.

The BTMS 200 or the air conditioning system 300 may control driving of the cooling processing unit 220 or the air conditioning processing unit 320 based on the received integrated control information, and may feed the parameters of the first or second candidate factors updated by the driving back to the integrated controller 400. In an operation S1170, the prediction device 500 may input the parameters of the first or second factors selected by and re-input from the integrated controller 400 to the temperature prediction model to predict the temperature of the plurality of zones.

The operations of the method or algorithm described in relation to the embodiments disclosed in the present specification may be implemented directly in hardware, a software module, or a combination of the two. The software module may reside in a storage medium (e.g., a memory) such as a random-access memory (RAM), a flash memory, a read-only memory (ROM), an erasable programmable read-only memory (EPROM), an electrically erasable programmable read-only memory (EEPROM), a register, a hard disk, a removable disk, or a compact disc (CD)-ROM. An example storage medium may be coupled to the processor, and the processor may read information from, and write information to, the storage medium. Alternatively, the storage medium may be integral to the processor. The processor and the storage medium may reside within an application-specific integrated circuit (ASIC). The ASIC may reside within a device. Alternatively, the processor and the storage medium may reside as separate components within the device. For example, the device may be at least one of a BMS 210, a BTMS controller 240, an air conditioning controller 340, an integrated controller 400, or a prediction device 500.

In addition, for example, the processors disclosed in the present disclosure may be implemented as at least one of a central processing unit (CPU), a digital signal processor (DSP), a programmable logic device (PLD), a field programmable gate array (FPGA), a microcontroller, and/or a microprocessor, or may include at least one of these.

While the example methods of the present disclosure described above are represented as a series of operations for clarity of description, it is not intended to limit the order in which the steps are performed, and the steps may be performed simultaneously or in different order as necessary. In order to implement the method according to embodiments of the present disclosure, the described steps may further include other steps, may include remaining steps except for some of the steps, or may include other additional steps except for some of the steps.

The various embodiments of the present disclosure are not a list of all possible combinations and are intended to describe representative aspects of the present disclosure, and the matters described in the various embodiments may be applied independently or in combination of two or more.

In addition, various embodiments of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands or computer-readable instructions (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

What is claimed is:

1. A battery and air conditioning control system comprising:
a prediction device configured to:
receive parameters of a plurality of first factors related to a battery thermal management system (BTMS) configured to manage a battery temperature of a vehicle and parameters of a plurality of second factors related to an air conditioning system configured to manage interior air conditioning of the vehicle, and
input the received parameters of the plurality of first and second factors to a temperature prediction model to predict an interior temperature of the vehicle; and
an integrated controller configured to control the BTMS and the air conditioning system in an integrated manner based on the predicted interior temperature and one or more set target interior temperatures.

2. The battery and air conditioning control system of claim 1, wherein the plurality of first and second factors includes factors selected from among a plurality of candidate factors associated with a plurality of actuators included in the BTMS and the air conditioning system, wherein the factors are selected based on a predetermined condition of correlation with an average interior temperature of the vehicle.

3. The battery and air conditioning control system of claim 2, wherein the average interior temperature of the vehicle is an average seat temperature of the vehicle.

4. The battery and air conditioning control system of claim 1, wherein the plurality of first and second factors includes two or more of a compressor temperature, an evaporator temperature, a battery cell temperature, a battery consumption voltage, a valve angle, an electric fan rotation speed, a refrigerant pressure, a warmer temperature, an inverter consumption current, an inverter temperature, a battery cooling sequence, an interior air temperature, an exterior air temperature, or a state of charge (SOC) change amount.

5. The battery and air conditioning control system of claim 1, wherein the prediction device is further configured to:
receive parameters of third factors related to a driving state of the vehicle; and
input the parameters of third factors to the temperature prediction model.

6. The battery and air conditioning control system of claim 1, wherein the prediction device is configured to predict the interior temperature of the vehicle for each of a plurality of zones from the parameters of the plurality of first and second factors.

7. The battery and air conditioning control system of claim 6, wherein the prediction device is further configured to determine an average of the interior temperatures predicted for each of the plurality of zones.

8. The battery and air conditioning control system of claim 6, wherein the plurality of zones includes zones in which a driver seat, one or more passenger seats, and one or more vents of the vehicle are located.

9. The battery and air conditioning control system of claim 6, wherein the temperature prediction model is trained based on the parameters of the plurality of first and second factors and an actual temperature detected for each of the plurality of zones of the vehicle.

10. The battery and air conditioning control system of claim 1, wherein the integrated controller is configured to:
determine one or more target actuators to be controlled among a plurality of actuators included in the BTMS and the air conditioning system based on the predicted interior temperature and the one or more set target interior temperatures;
generate, for each of the one or more target actuators, a control value for controlling the target actuator; and
output the generated control value to a system, among the BTMS and the air conditioning system, that includes the target actuator,
wherein the system that includes the target actuator is configured to control operation of the target actuator based on the received control value.

11. A battery and air conditioning control method comprising:
receiving, by a prediction device, parameters of a plurality of first factors related to a battery thermal management system (BTMS) configured to manage a battery temperature of a vehicle and parameters of a plurality of second factors related to an air conditioning system configured to manage interior air conditioning of the vehicle;
inputting, by the prediction device, the parameters of the plurality of first and second factors to a temperature prediction model;
predicting, by the prediction device, using the temperature prediction model, an interior temperature of the vehicle based on the parameters of the plurality of first and second factors; and
controlling, by an integrated controller, the BTMS and the air conditioning system in an integrated manner based on the predicted interior temperature and one or more set target interior temperatures.

12. The battery and air conditioning control method of claim 11, wherein the plurality of first and second factors include factors selected from among a plurality of candidate factors associated with a plurality of actuators included in the BTMS and the air conditioning system, wherein the factors are selected based on a predetermined condition of correlation with an average interior temperature of the vehicle.

13. The battery and air conditioning control method of claim 12, wherein the average interior temperature of the vehicle is an average seat temperature of the vehicle.

14. The battery and air conditioning control method of claim 11, wherein the plurality of first and second factors include two or more of compressor temperature, evaporator temperature, exterior air temperature, battery cell temperature, battery consumption voltage, valve angle, electric fan rotation speed, refrigerant pressure, warmer temperature, inverter consumption current, inverter temperature, battery cooling sequence, interior air temperature, exterior air temperature, or state of charge (SOC) change amount.

15. The battery and air conditioning control method of claim 11, further comprising:
receiving parameters of third factors related to a driving state of the vehicle; and
inputting the parameters of third factors to the temperature prediction model.

16. The battery and air conditioning control method of claim 11, wherein predicting the interior temperature of the vehicle includes predicting the interior temperature of the vehicle for each of a plurality of zones, based on the parameters of the plurality of first and second factors.

17. The battery and air conditioning control method of claim 16, wherein predicting the interior temperature of the vehicle includes determining an average of the interior temperatures predicted for each of the plurality of zones.

18. The battery and air conditioning control method of claim 16, wherein the plurality of zones includes zones in which a driver seat, one or more passenger seats, and one or more vents of the vehicle are located.

19. The battery and air conditioning control method of claim 16, wherein the temperature prediction model is trained based on the parameters of the plurality of first and second factors and an actual temperature detected for each of the plurality of zones of the vehicle.

20. The battery and air conditioning control method of claim 11, wherein the controlling in an integrated manner includes:
determining, by the integrated controller, one or more target actuators to be controlled, among a plurality of actuators included in the BTMS and the air conditioning system based on the predicted interior temperature and the one or more set target interior temperatures;
generating, by the integrated controller for each of the one or more target actuators, a control value for controlling the target actuator; and
outputting, by the integrated controller, the generated control value to a system, among the BTMS and the air conditioning system, that includes the target actuator,
wherein the system that includes the target actuator is configured to control operation of the target actuator based on the received control value.
